(19) United States
(12) Patent Application Publication
(10) Pub. No.: US 2025/0106931 A1
(43) Pub. Date: Mar. 27, 2025

(54) RESOURCE EFFICIENT DELIVERY OF MULTICAST AND BROADCAST SERVICE

(71) Applicant: ZTE Corporation, Shenzhen (CN)

(72) Inventors: Tao QI, Shenzhen (CN); Yang LI, Shenzhen (CN); Lin CHEN, Shenzhen (CN)

(21) Appl. No.: 18/976,992

(22) Filed: Dec. 11, 2024

Related U.S. Application Data
(63) Continuation of application No. PCT/CN2022/111242, filed on Aug. 9, 2022.

(51) Int. Cl. H04W 76/20; H04W 48/20; H04W 72/12; H04W 72/54

(52) U.S. Cl. CPC H04W 76/20; H04W 48/20; H04W 72/12; H04W 72/54

(57) ABSTRACT

Methods and systems for techniques for enabling wireless devices to receive multicast services in a radio resource control inactive (RRC_INCTIVE) state are disclosed. In an implementation, a method of wireless communication includes receiving, by a first network node, from a second network node, a session management signaling that include an alternative quality of service profile, and transmitting, by the first network node, to a wireless device, multicast session data based on the alternative quality of service profile during a radio resource control inactive period.

### CROSS-REFERENCE TO RELATED APPLICATION

This application is a continuation and claims priority to International Application No. PCT/CN2022/111242, filed on Aug. 9, 2022, the disclosure of which is hereby incorporated by reference herein in its entirety.

### TECHNICAL FIELD

This patent document is directed generally to wireless communications.

### BACKGROUND

Mobile communication technologies are moving the world toward an increasingly connected and networked society. The rapid growth of mobile communications and advances in technology have led to greater demand for capacity and connectivity. Other aspects, such as energy consumption, device cost, spectral efficiency, and latency are also important to meeting the needs of various communication scenarios. Various techniques, including new ways to provide higher quality of service, longer battery life, and improved performance are being discussed.

### SUMMARY

This patent document describes, among other things, techniques for enabling wireless devices to receive multicast services in a radio resource control inactive (RRC_INCTIVE) state.

In one aspect, a method of data communication is disclosed. The method includes receiving, by a first network node, from a second network node, a session management signaling that include an alternative quality of service profile, and transmitting, by the first network node, to a wireless device, multicast session data based on the alternative quality of service profile during a radio resource control inactive period.

In another aspect, a method of data communication is disclosed. The method includes receiving, by a wireless device, a configuration associated with a multicast session from a network node, wherein the configuration assists the wireless device to receive or continue receiving the multicast session in one specific cell, and receiving, by the wireless device, multicast session data after transitioning to a radio resource control inactive state.

In another aspect, a method of data communication is disclosed. The method includes obtaining, by a wireless device, assistant information provided from an application layer or a service layer to an access layer, and receiving, by the wireless device, a point-to-multipoint configuration associated with a multicast and broadcast service.

In another aspect, a method of data communication is disclosed. The method includes receiving, by a wireless device, a network configuration to report a receive-only-mode (ROM) service configuration, and transmitting, by the wireless device, to a network node, a ROM report associated with a ROM service being received or to be received by the wireless device based on the network configuration.

In another aspect, a method of data communication is disclosed. The method includes transmitting, by a wireless device, to a network node, a first receive-only-mode (ROM) report associated with a ROM service being received or to be received by the wireless device to report an ROM service configuration, receiving, by the wireless device, an inquiry from the network node regarding a second ROM report for the network node, and transmitting, by the wireless device, to the network node, the second ROM report for the network node.

In another aspect, a method of data communication is disclosed. The method includes transmitting, by a wireless device, to a network node, a first receive-only-mode (ROM) report associated with a ROM service being received or to be received by the wireless device to report an ROM service configuration, receiving, by the wireless device, an indication for the wireless device to transmit an updated ROM report to the network node, and transmitting, by the wireless device, to the network node, the updated report in a case that the report of the update of the ROM report is enabled by network and if the ROM service configuration has been updated.

In another example aspect, a wireless communication apparatus comprising a processor configured to implement an above-described method is disclosed.

In another example aspect, a computer storage medium having code for implementing an above-described method stored thereon is disclosed.

These, and other, aspects are described in the present document.

### BRIEF DESCRIPTION OF THE DRAWING

FIG. 1 shows an example of a wireless communication system based on some example embodiments of the disclosed technology.

FIG. 2 is a block diagram representation of a portion of an apparatus based on some embodiments of the disclosed technology.

FIG. 3 shows an example of UE that is released to an RRC inactive state continues to receive multicast communication on SCell.

FIG. 4 shows an example of a process for wireless communication based on some example embodiments of the disclosed technology.

FIG. 5 shows another example of a process for wireless communication based on some example embodiments of the disclosed technology.

FIG. 6 shows another example of a process for wireless communication based on some example embodiments of the disclosed technology.

FIG. 7A shows a reporting procedure of a partial or full receive-only-mode (ROM) report. FIG. 7B shows a reporting procedure of ROM report based on a network inquiry. FIG. 7C shows an updating procedure of ROM report.

FIG. 8 shows another example of a process for wireless communication based on some example embodiments of the disclosed technology.

FIG. 9 shows another example of a process for wireless communication based on some example embodiments of the disclosed technology.

FIG. 10 shows another example of a process for wireless communication based on some example embodiments of the disclosed technology.

### DETAILED DESCRIPTION

Section headings are used in the present document only for ease of understanding and do not limit scope of the embodiments to the section in which they are described. Furthermore, while embodiments are described with reference to 5G examples, the disclosed techniques may be applied to wireless systems that use protocols other than 5G or 3GPP protocols.

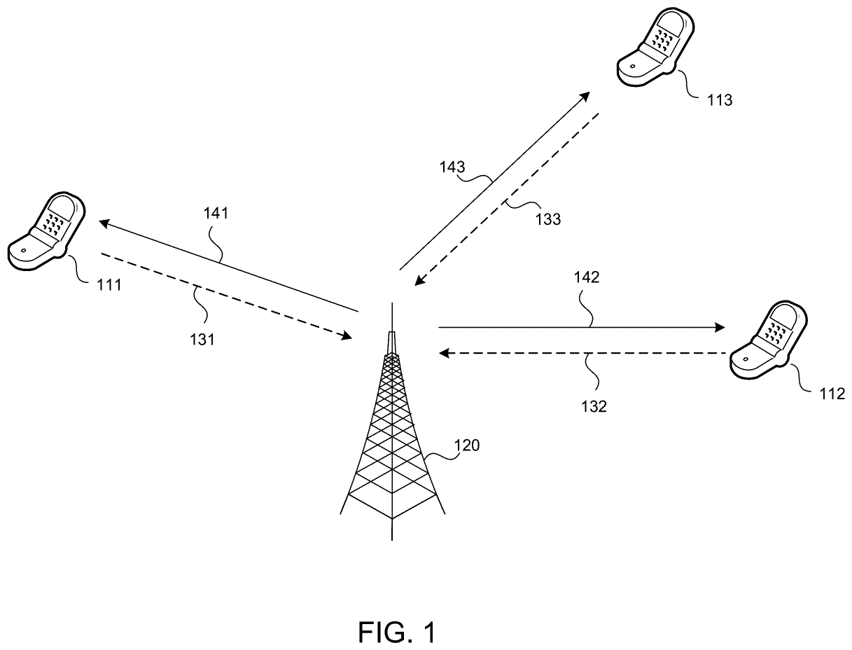

FIG. 1 shows an example of a wireless communication system (e.g., a long term evolution (LTE), 5G or NR cellular network) that includes a BS 120 and one or more user equipment (UE) 111, 112 and 113. In some embodiments, the uplink transmissions (131, 132, 133) can include uplink control information (UCI), higher layer signaling (e.g., UE assistance information or UE capability), or uplink information. In some embodiments, the downlink transmissions (141, 142, 143) can include DCI or high layer signaling or downlink information. The UE may be, for example, a smartphone, a tablet, a mobile computer, a machine to machine (M2M) device, a terminal, a mobile device, an Internet of Things (IoT) device, and so on.

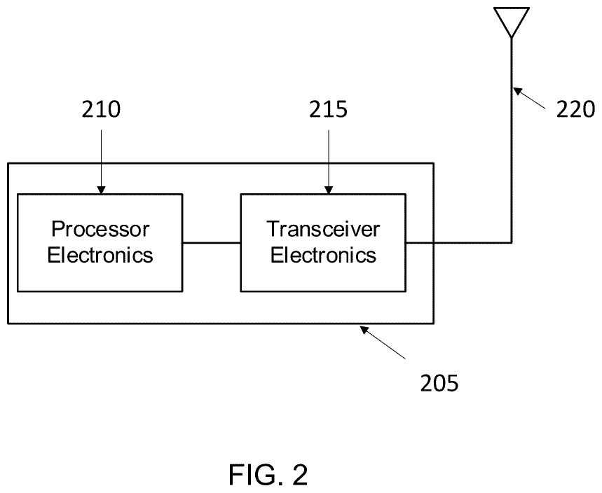

FIG. 2 is a block diagram representation of a portion of an apparatus based on some embodiments of the disclosed technology. An apparatus 205 such as a network device or a base station or a wireless device (or UE), can include processor electronics 210 such as a microprocessor that implements one or more of the techniques presented in this document. The apparatus 205 can include transceiver electronics 215 to send and/or receive wireless signals over one or more communication interfaces such as antenna(s) 220. The apparatus 205 can include other communication interfaces for transmitting and receiving data. Apparatus 205 can include one or more memories (not explicitly shown) configured to store information such as data and/or instructions. In some implementations, the processor electronics 210 can include at least a portion of the transceiver electronics 215. In some embodiments, at least some of the disclosed techniques, modules or functions are implemented using the apparatus 205.

With the introduction of New Radio (NR) Multicast and Broadcast Services (MBS) in 5G systems (5GS), 5GS will get a reliable alternative that enables efficient data delivery by utilizing the broadcast nature of wireless communication.

The disclosed technology can be implemented in some embodiments to provide the scalability of MBS: by enabling UE to receive a multicast service in a radio resource control inactive (RRC_INACTIVE) state, including the network behavior upon making such decision and the information needed from 5GC, and also in the case of multicast reception on the SCell other than the PCell in which a mechanism is defined for the sake of service continuity during the RRC state transitioning; by enabling UE to receive a broadcast service from a public land mobile network (PLMN) that is different from a PLMN that provides UE's unicast connection; and by providing MBS in the case of network sharing, the network is able to support such network sharing with minimized overhead on Uu interface.

For multicast services defined by 3GPP, both UE in a radio resource control connected (RRC_CONNECTED) state and UE in a radio resource control inactive (RRC_INACTIVE) state are to be supported for different services with diverse requirements, e.g., the network is able to provide some advanced feature to provide a higher reliability to UE in the radio resource control connected (RRC_CONNECTED) state. For multicast services like the mission critical push to talk (MCPTT) with a large number of reception UEs in one cell, or when there is an energy saving requirement for UE, a multicast reception can be done for UE in the radio resource control inactive (RRC_INACTIVE) state to release the network resources or reduce power consumption that maintains UE in the radio resource control connected (RRC_CONNECTED) state.

There are benefits to enable UE to receive the multicast service in the radio resource control inactive (RRC_INACTIVE) state. For mission critical communication services over multicast defined in a cellular network, there are following requirements:

The main driver for this key issue is to enable service for a large number of UEs in a cell.

In general, UEs can be refused admission to a cell based on several limiting factors that include a maximum number of connected UEs and the amount of traffic in the cell. Based on the public safety group call model, the amount of traffic in the cell can be relatively low in comparison to other types of traffic, because public safety UEs engaged in group calls have the capability to use (share) only one bearer (multicast) for downlink and it is usual to have only one UE transmitting at a time.

The issues include how to identify the traffic model for group call from the point of view of how resources needed and consumed at various points in time during the group call may impact the pre-emption and admission of bearers and UE.

Since there is a distinct possibility that the large number of UEs may exceed the limit that can be serviced in a cell, study potential procedures for UEs to receive and participate in service in those situations;

Since there is a distinct possibility that some number of UEs may end up with no or limited service due to being too numerous within a cell, study ways of providing information to various involved subsystems indicating which UEs to be selected for service exclusion/degradation and recovery.

Currently, once the uplink (side of the) unicast radio bearer (typically Guaranteed Bit Rate (GBR)) is established for a group call, it stays allocated to the UE for the entire duration of the group call, whether the user ever talks or not. However, the traffic model for group call shows that the radio bearer may be actually used relatively rarely, namely only when the user has the floor. In the case of mission critical broadcast group none of the user except for one talker can have the floor.

The proposed solution is for UEs to have an uplink GBR bearer only while they hold the floor. That assumes an ability to quickly assign and release the radio bearer (or most of the bandwidth associated with it), such that the key performance indicators (KPIs) associated with the group call of that type can still be met when the user activates the PTT key.

According to the current standard, the time for (unicast, GBR) radio bearer setup in LTE is 115 ms, including estimated (10 ms radio link delay, 5 ms network interface delay and 5 ms processing delay). Noting that the UE is already in connected mode rather than the idle mode, so that transition time is saved, it may be possible to run part of the radio bearer setup while the floor control request is being processed, with the net result that it should be possible to both allocate (or expand the uplink bandwidth of) the radio bearer on demand and meet the KPI 1 requirement, per the current standard.

The standardization group experts are working on defining signaling mechanisms for effecting quick and temporary changes of the bandwidth associated with the uplink bearer, normally triggered by floor control signaling. The uplink floor control (which is typically a small(S) RTCP packet) messages can be sent via the reduced-bandwidth uplink bearer or via separate (usually non-GBR) radio bearer.

The mission critical application server (MC AS) may want to have remediation or mitigation of the reported condition. For example, the MC AS may affect some of the UEs in the cells reported to have high congestion to transition to receive data in idle mode in order to avoid the chance of the UEs being pre-empted.

When it comes to transmission, the UEs receiving data in idle mode will have a potentially degraded service, as their access time to obtain uplink radio bearers will be longer than in the case of UEs in a “normal” mode of operation.

Based on the way they are configured, the UEs may attempt to access the cell shortly, when directed by user, upon mobility events, or when they need to update some parameters.

The scenarios above require the following design considerations for multicast services in Radio Access Network (RAN): (1) the maximum UE number in one cell is limited, thus not all UE might be in radio resource control connected (RRC_CONNECTED) states; (2) in rare cases one UE might need to apply the floor control to carry out uplink transmissions. However, it is expected the latency for the UE to be able to carry out uplink transmissions is lower.

Therefore, it is expected that UE is able to do the multicast reception in radio resource control inactive (RRC_INACTIVE) states, while resuming RRC connection to be able to do uplink with lower latency. The radio resource control inactive (RRC_INACTIVE) state was introduced in 5G NR such that UE context in access layer is kept in Radio Access Network (RAN), and such mechanism enables that UE can stay in a lower power mode with less network resource consumption, and resume the RRC connection with lower latency and less signaling overhead.

One solution for the above multicast reception mission critical push to talk (MCPTT) scenarios is to enable UE to receive multicast service in the radio resource control inactive (RRC_INACTIVE) state: when the network resource is scarce, UEs can be released to radio resource control inactive (RRC_INACTIVE) state; for UEs that have uplink requirements, e.g., UE that intends to take the floor control and send voices or videos, UE can be sent back to radio resource control connected (RRC_CONNECTED) state with low latency.

To maximize the scalability of MBS service delivery in RAN, there are other measures to be supported: the MBS service delivered by one public land mobile network (PLMN) can be received by the UE that is connected to another PLMN; the MBS service can be delivered in case of network sharing, and the overhead on duplicated resource consumption needs to be avoided.

In some implementations of the disclosed technology, the word “MBS” can be used to identify a service that can be MBS multicast service or MBS broadcast service. In some examples, the terms “MBS multicast service” or “multicast service”, and “MBS broadcast service” or “broadcast service” can be explicitly used.

For broadcast communication service, the same service and the same specific content data are provided simultaneously to all UEs in a geographical area (e.g., all UEs in the broadcast service area are authorized to receive the data). A broadcast communication service is delivered to the UEs using a broadcast session. A UE can receive a broadcast communication service in RRC_IDLE, RRC_INACTIVE and RRC_CONNECTED states.

For multicast communication service, the same service and the same specific content data are provided simultaneously to a dedicated set of UEs (e.g., not all UEs in the multicast service area are authorized to receive the data). A multicast communication service is delivered to the UEs using a multicast session. A UE can receive a multicast communication service in RRC_CONNECTED state or RRC_INACTIVE state with mechanisms such as PTP and/or PTM delivery. HARQ feedback/retransmission can be applied to both point-to-point (PTP) and point-to-multipoint (PTM) transmission.

In some implementations of the disclosed technology, PTM configuration can indicate a point-to-multicast configuration based on which UE receives the MBS data.

In some implementations of the disclosed technology, it is assumed that not all multicast services can be or need to be scheduled to UE in RRC_INACTIVE state. RAN node decides based on the information received from 5GC, e.g., quality of service (QOS) information, and the availability of the radio resources information to schedule the multicast service for UE in RRC_CONNECTED and/or RRC_INACTIVE.

For the MBS services that are delivered to UE in an RRC_INACITVE state, the QoS might be compromised. Compared to not being able to provide the service at all, it might be the optimal solution to provide or continue providing the service with compromised QoS. Therefore, an alternative QoS may be provided from 5GC for a certain QoS flow of the MBS session in a case that gNB needs to schedule the service with the alternative QoS, which might be a compromised QoS.

In some embodiments of the disclosed technology, a prioritized list of alternative QoS profile(s) can be provided to the NG-RAN for a multicast session.

In one example, if only alternative QoS profile(s) for such a multicast session is received from 5GC, the network is allowed to schedule the multicast session transmitted for UE in RRC_INACTIVE. That is, if there is no alternative QoS received from 5GC, the multicast service can only be delivered to UE in RRC_CONNECTED.

In another example, if an alternative QoS profile is received from 5GC, the network schedules the multicast session transmitted for UE in RRC_INACTIVE with the first alternative QoS profile in the list such that the network can have values that match an Alternative QoS Profile.

In another example, if configured with the multicast session that is to be scheduled for UE in RRC_INACTIVE with alternative QoS profile, gNB triggers a notification to 5GC about the scheduling decision with reference to the Alternative QoS Profile the RAN can satisfy.

In another example, if configured with the multicast session that is to be scheduled for UE back to RRC_CONNECTED, gNB triggers a notification to 5GC about the scheduling decision to allow UE to receive the multicast session in RRC_CONNECTED with the normal QoS profile.

In some embodiments of the disclosed technology, the alternative QoS profile is provided in a protocol data unit (PDU) session context, and the PDU session is associated with the multicast session.

### Example Set 1

Various implementations of features of the disclosed technology can be made based on the examples listed below.

Example 1. To enable a Radio Access Network (RAN) node to deliver a multicast session to UE in RRC_INACTIVE, Alternative QoS Profile is received by the RAN node in a session management signaling, and the RAN node, based on the Alternative QoS Profile, transmits the multicast session data for UE in RRC_INACTIVE.

Example 2. The method of example 1, wherein if only Alternative QoS Profile(s) for one multicast session is received from 5G core network (5GC), the RAN node is allowed to schedule the multicast session transmitted for UE in RRC_INACTIVE.

Example 3. The method of example 1, wherein if an alternative QoS profile is received from 5GC, the network schedules the multicast session transmitted for UE in RRC_INACTIVE with the first alternative QoS profile in the list that the network is able to fulfill values that match an Alternative QoS Profile.

Example 4. The method of example 3, wherein the session management signaling also includes a notification control enabled indication, if the multicast service is to be scheduled for UE in RRC_INACTIVE with an alternative QoS profile, gNB triggers a notification to 5GC about the scheduling decision with reference to the Alternative QoS Profile the RAN is able to fulfill.

Example 5. The method of example 4, wherein the session management signaling also includes a notification control enabled indication, if the multicast service is to be scheduled for UE to transition back to RRC_CONNECTED, gNB triggers a notification to 5GC about the scheduling decision to allow UE to receive the multicast session in RRC_CONNECTED with the normal QoS profile.

Example 6. The method of examples 1, 4 or 5, wherein the session management signaling is the PDU session management signaling for one UE's PDU session that is associated with the multicast session.

Example 7. The method of examples 1, 4 or 5, wherein the session management signaling is the multicast session management signaling per multicast session.

In some embodiments of the disclosed technology, UE continues to receive multicast transmissions on SCell.

A multicast session can be configured on one UE's SCell. If the UE is to be released to RRC_INACTIVE state, UE ceases to receive data even if the configuration might not be released at UE side. Therefore, the multicast reception will be interrupted, e.g., if the PTM configuration of the multicast is delivered by a dedicated signaling, the multicast reception will be interrupted, or if the multicast service is not provided in the cell the UE camps on, the service reception will be interrupted.

The disclosed technology can be implemented in some embodiments to provide an enhanced mechanism for allowing UE to receive or continue receiving the multicast data on the SCell configured when UE was in RRC_CONNECTED with a minimized delay or interruption.

UE may receive the multicast data based on two different delivery method, i.e., by a dedicated signaling or by a broadcast signaling.

If UE is to receive the multicast data based on the configuration in the dedicated signaling, UE obtains the PTM configuration of the multicast session in SCell by a dedicate RRC signaling.

If UE is to receive the multicast data based on the configuration in the broadcast signaling, UE obtains the PTM configuration of the multicast session in SCell based on the information System Information Block 20 (SIB20) and multicast and broadcast service control channel (MCCH) of the SCell, while the SIB20 and or MCCH might be received by UE in a broadcast signaling after camping on the SCell, or SIB20 and/or MCCH is delivered to UE by dedicated signaling before UE is released to RRC_INACTIVE.

The solution is presented in following examples, with different assumption on how UE received the PTM configuration.

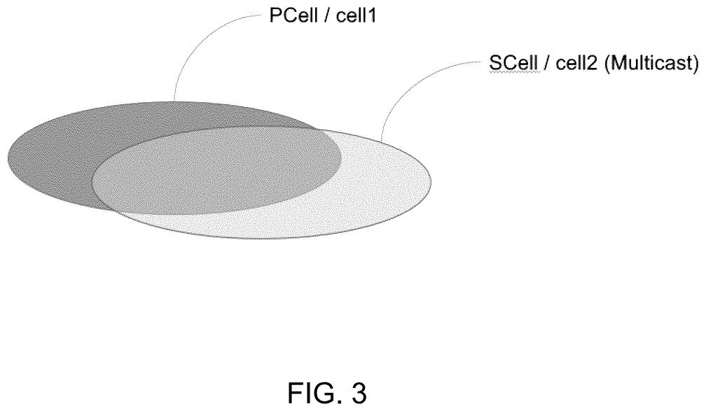

FIG. 3 shows an example of UE that is released to an RRC inactive state continues to receive multicast communication on SCell.

In one example, UE is configured with carrier aggregation (e.g., PCell and SCell), and the multicast service can be provided on the SCell. Therefore, if UE is to be released from RRC_CONNECTED to RRC_INACTIVE, all the data reception behavior on SCell will be stopped. There are a few options to be considered to reduce potential service interruptions. It is assumed that the multicast session is the service to be scheduled to UE in RRC_INACTIVE.

In one example, UE is indicated by the network the cell to be prioritized camps on. In such a case, the SCell is indicated to the UE after being released, and UE camps on the SCell to receive or continue receiving the multicast service in RRC_INACTIVE state.

In one example, the network may prioritize the cell that provides the multicast data by indicating an offset that is temporarily applied to a cell for the indicated cell, and therefore, during the cell selection phase, UE is able to select the cell with a multicast with a higher probability. For example, in the current cell selection criteria framework, the cell selection criterion S is fulfilled when:

Srxlev>0 AND Squal>0

where:

$$Srxlev = {Q}_{rxlevmeas} - ( {Q}_{rxlevmin} + {Q}_{rxlevminoffset} ) - {P}_{compensation} - {Qoffset}_{temp} \\ Squal = {Q}_{qualmeas} - ( {Q}_{qualmin} + {Q}_{qualminoffset} ) - {Qoffset}_{temp}$$

where:

| | |
|---|---|
| Srxlev | Cell selection RX level value (dB) |
| Squal | Cell selection quality value (dB) |
| Qoffsetₜₑₘₚ | Offset temporarily applied to a cell (dB) |
| Qrxlevmeas | Measured cell RX level value (RSRP) |
| Q_{qualmeas} | Measured cell quality value (RSRQ) |
| Qᵣₓₗₑᵥₘᵢₙ | Minimum required RX level in the cell (dBm). If the UE supports SUL frequency |
| | for this cell, Qᵣₓₗₑᵥₘᵢₙ is obtained from q-RxLevMinSUL, if present, in SIB1, SIB2 |
| | and SIB4, additionally, if Q_{rxlevminoffsetcellSUL} is present in SIB3 and SIB4 for the |
| | concerned cell, this cell specific offset is added to the corresponding Qrxlevmin to |
| | achieve the required minimum RX level in the concerned cell; |
| | else Qᵣₓₗₑᵥₘᵢₙ is obtained from q-RxLevMin in SIB1, SIB2 and SIB4, additionally, |
| | if Q_{rxlevminoffsetcell} is present in SIB3 and SIB4 for the concerned cell, this cell |
| | specific offset is added to the corresponding Qrxlevmin to achieve the required |
| | minimum RX level in the concerned cell. |
| Q_{qualmin} | Minimum required quality level in the cell (dB). Additionally, if Q_{qualminoffsetcel}l is |
| | signalled for the concerned cell, this cell specific offset is added to achieve the |
| | required minimum quality level in the concerned cell. |
| Q_{rxlevminoffset} | Offset to the signaled Qᵣₓₗₑᵥₘᵢₙ taken into account in the Srxlev evaluation as a |
| | result of a periodic search for a higher priority PLMN while camped normally in a |
| | VPLMN, as specified in the standard. |
| Q_{qualminoffset} | Offset to the signalled Qqualmin taken into account in the Squal evaluation as a |
| | result of a periodic search for a higher priority PLMN while camped normally in a |
| | VPLMN, as specified in the standard. |
| P_{compensation} | For FR1, if the UE supports the additionalPmax in the NR-NS-PmaxList, if |
| | present, in SIB1, SIB2 and SIB4: |
| | max(P_{EMAX1} − P_{PowerClass}, 0) − (min(P_{EMAX2}, P_{PowerClass}) − min(P_{EMAX1}, P_{PowerClass})) |
| | (dB); |
| | else: |
| | max(P_{EMAX1} − P_{PowerClass}, 0) (dB) |
| | For FR2, P_{compensation} is set to 0. |
| | For IAB-MT, P_{compensation} is set to 0. |
| P_{EMAX1}, P_{EMAX2} | Maximum TX power level of a UE may use when transmitting on the uplink in |
| | the cell (dBm) defined as PEMAX, as specified in the standard. If UE supports |
| | SUL frequency for this cell, P_{EMAX1} and P_{EMAX2} are obtained from the p-Max for |
| | SUL in SIB1 and NR-NS-PmaxList for SUL respectively in SIB1, SIB2 and SIB4 |
| | as specified in the standard, else P_{EMAX1} and P_{EMAX2} are obtained from the p-Max |
| | and NR-NS-PmaxList respectively in SIB1, SIB2 and SIB4 for normal UL, as |
| | specified in the standard. |
| P_{PowerClass} | Maximum RF output power of the UE (dBm) according to the UE power class as |
| | defined in the standard. |

Therefore, Qoffsetₜₑₘₚ is configured for UE together with the indicated cell (e.g., SCell) to help UE to select the serving cell to continue the multicast data reception.

In another example, based on the associated cell where the multicast is scheduled before UE is released, and also the multicast service is to be scheduled to UE in RRC_INACTIVE, UE considers the associated cell that is prioritized and camps on the associated cell. For example, UE may receive the multicast data based on the dedicated signaling, which carries a cell group configuration that includes the multicast scheduling information. The cell group configuration is associated with one cell. If UE is to receive the multicast data based on broadcast signaling, e.g., MCCH, the cell that MCCH is scheduled on is the associated cell.

In the above examples, UE keeps synced to SCell and the multicast configuration associated with the SCell to continue the multicast data reception.

### Example Set 2

Various implementations of features of the disclosed technology can be made based on the examples listed below.

Example 1. To enable a multicast session delivery to UE in RRC_INACTIVE with less interruption, UE receives a configuration associated with the multicast session from the network, UE receives or continues receiving the multicast session data after being released to RRC_INACTIVE state.

Example 2. The method of example 1, wherein the configuration associated with the multicast session includes cell information, and UE considers the cell with the highest priority during a cell selection, and camps on the indicated cell and receives or continues receiving the multicast session data after being released to RRC_INACTIVE state.

Example 3. The method of example 1, wherein the configuration associated with the multicast session includes the cell information and an offset value for the indicated cell, and UE selects the suitable cell based on the offset value.

Example 4. The method of example 1, wherein the configuration associated with the multicast session from network is the scheduling information of the multicast session, which includes the cell information on which the multicast is being scheduled, and UE considers the cell with the highest priority during a cell selection, and camps on the indicated cell and receives or continues receiving the multicast session data after being released to RRC_INACTIVE state.

Example 5. The method of example 1, wherein UE keeps synced to SCell and the multicast configuration associated with the SCell to continue the multicast data reception.

The disclosed technology can be implemented in some embodiments to carry out MBS reception in the case of network sharing.

In the case of network sharing, multiple Multi-Operator Core Networks (MOCNs) from different PLMNs might connect to the same RAN node, e.g., gNB. To avoid duplicated resources being allocated to the same MBS services, RAN recognizes that even the MBS session with different session ID, e.g., TMGI or IP multicast address are actually of the same MBS service in the application layer. In addition, RAN avoids duplicated resources to the recognized same MBS service. In some implementations, for the same MBS broadcast session, there is one common set of PTM configuration in the MCCH, and one common point-to-multipoint traffic channel (MTCH) resource allocated.

In some implementations of the disclosed technology, UE may be configured with multiple TMGIs associated with the same broadcast service, and therefore UE is able to associate with this TMGI list. If UE is able to provide such TMGI list from a service layer to an access layer, UE is able to receive the broadcast service on Uu interface with one of the TMGIs in the TMGI list.

In one example, UE provides the list of TMGI from the service layer to the access layer. By looking into the service list in the MCCH, UE is able to match the TMGI list with the TMGI list in the MCCH. If any of the TMGIs provided in the service layer (e.g., User service description) matches the TMGI provided in the MCCH, UE receives the broadcast data based on the PTM configuration identified by the recognized TMGI. The TMGI information from the service layer may also include the PLMN information, and therefore UE is able to precisely match the TMGI information, which also includes PLMN information in the MCCH.

Depending on whether it is explicit PLMN information in the TMGI IE or a PLMN index, UE is able to recover the complete TMGI that includes the complete PLMN and the service ID. Such TMGI is able to uniquely identify the MBS across PLMNs.

### Example Set 3

Various implementations of features of the disclosed technology can be made based on the examples listed below.

Example 1. To avoid duplicated radio resources allocated for the same MBS service in the case of network sharing, assistant information is provided from an upper layer to an access layer, UE based on such information to receive the PTM configuration of the MBS service.

Example 2. The method of example 1, wherein the assistant information is a TMGI list in which the TMGI is associated with the same MBS service.

Example 3. The method of example 2, wherein the assistant information that includes the TMGI list is included in the User service description provided in the service layer.

Example 4. The method of example 2, wherein UE compares the TMGI list with the TMGI list in the MCCH, for any recognized TMGI that is included in the MCCH is also included in the TMGI list from upper layer, and UE receives the MBS data based on the PTM configuration identified by the recognized TMGI in MCCH.

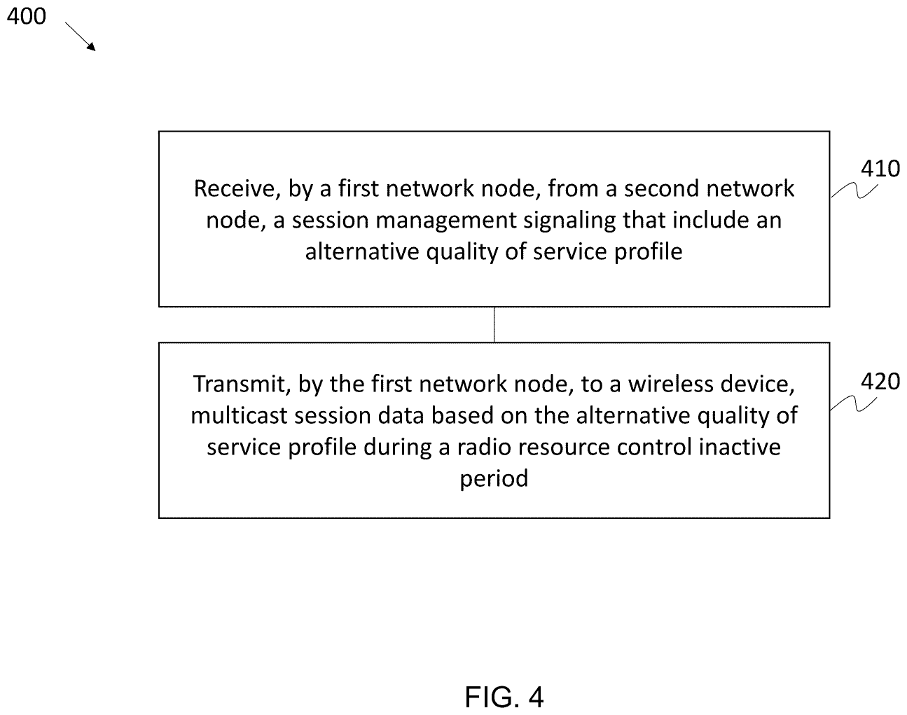

FIG. 4 shows an example of a process for wireless communication based on some example embodiments of the disclosed technology.

In some implementations, the process 400 for wireless communication may include, at 410, receiving, by a first network node, from a second network node, a session management signaling that include an alternative quality of service profile, and, at 420, transmitting, by the first network node, to a wireless device, multicast session data based on the alternative quality of service profile during a radio resource control inactive period.

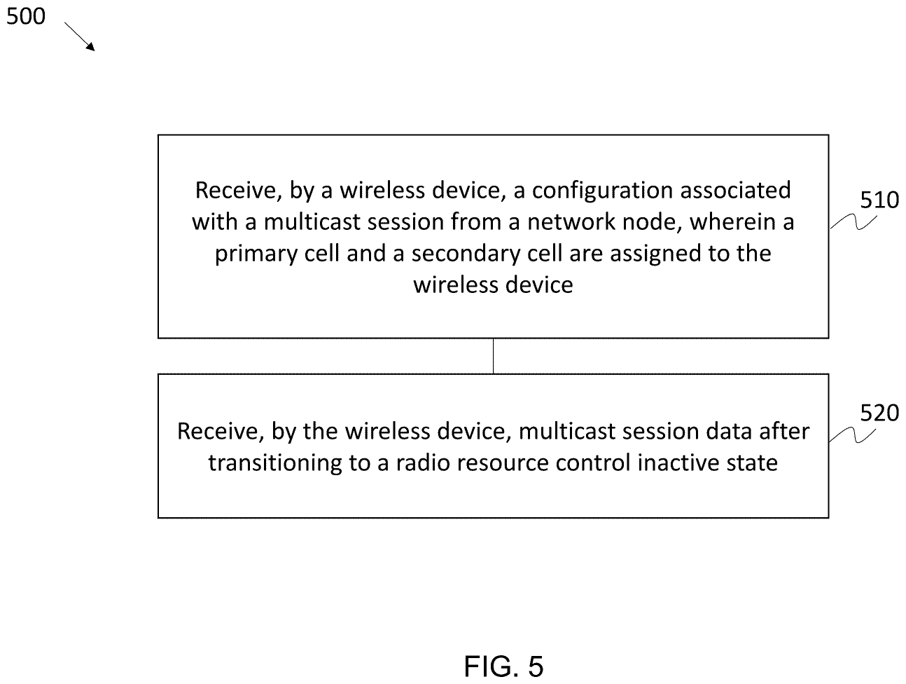

FIG. 5 shows another example of a process for wireless communication based on some example embodiments of the disclosed technology.

In some implementations, the process 500 for wireless communication may include, at 510, receiving, by a wireless device, a configuration associated with a multicast session from a network node, wherein a primary cell and a secondary cell are assigned to the wireless device, and, at 520, receiving, by the wireless device, multicast session data after transitioning to a radio resource control inactive state.

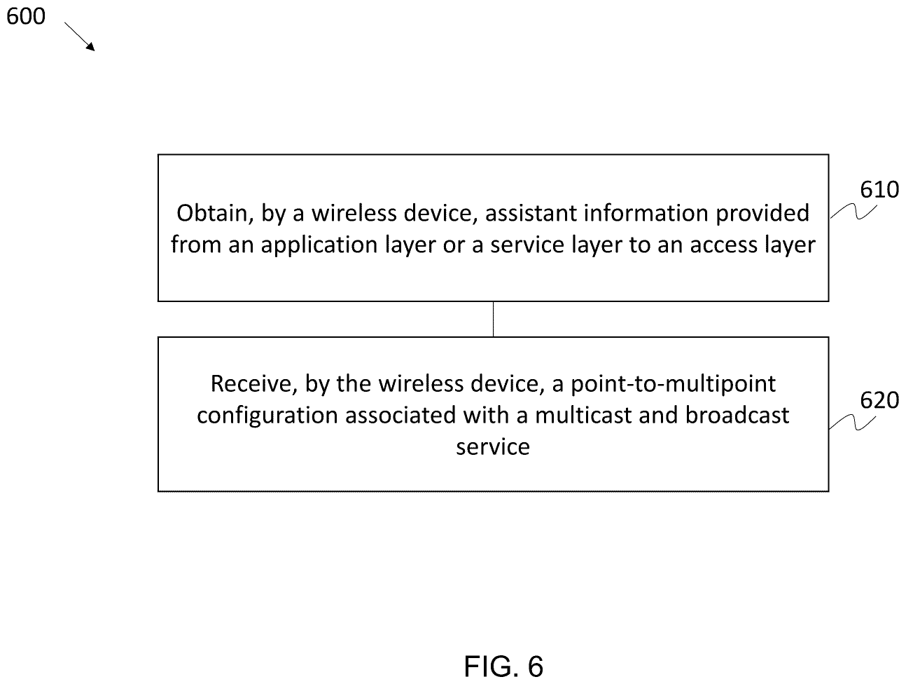

FIG. 6 shows another example of a process for wireless communication based on some example embodiments of the disclosed technology.

In some implementations, the process 600 for wireless communication may include, at 610, obtaining, by a wireless device, assistant information provided from an application layer or a service layer to an access layer, and, at 620, receiving, by the wireless device, a point-to-multipoint configuration associated with a multicast and broadcast service.

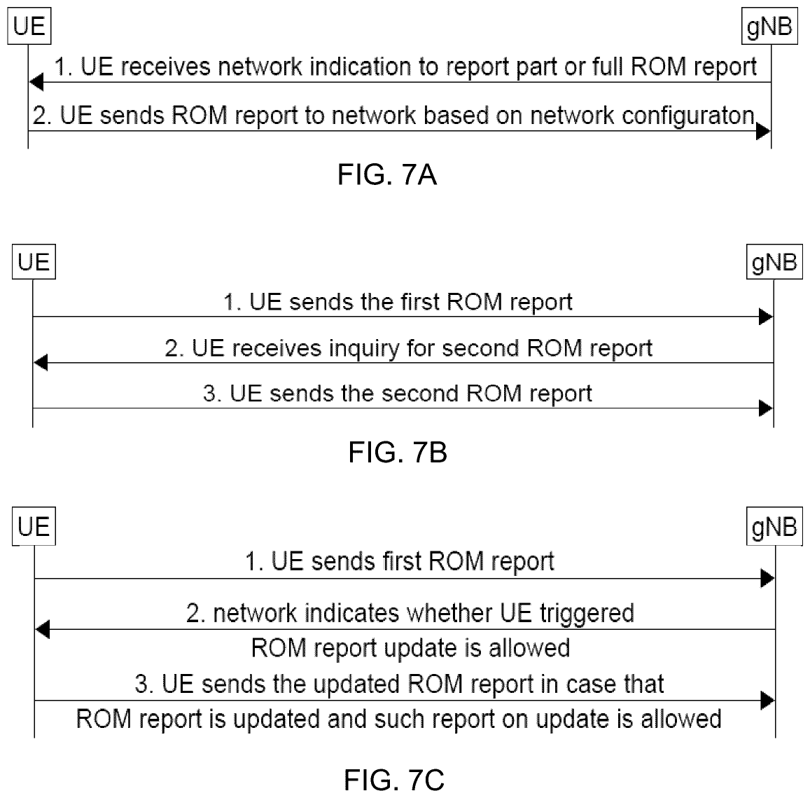

FIG. 7A shows a reporting procedure of a partial or full receive-only-mode (ROM) report. FIG. 7B shows a reporting procedure of ROM report based on a network inquiry. FIG. 7C shows an updating procedure of ROM report.

### Example Set 4

The Rel-17 NR MBS broadcast solution allows that the UE receives a broadcast service in a downlink only manner, e.g., performing a broadcast reception without a need to access the network beforehand. Such a multicast and broadcast service (MBS) broadcast service may be referred to as a receive-only-mode (ROM) service. However, in the typical use case for broadcast, the UE may be required to simultaneously receive a broadcast service and a unicast service from the network(s) of the same or another operator, and some UEs may share the hardware resources between broadcast and unicast. Therefore, the unicast connection might be impacted by the broadcast reception for this kind of UEs. One example solution is to enable UE to report the ROM service configuration that indicates the occupation of UE capability resulting from such a service to assist the network in making a better scheduling decision, e.g., better handover decision, or scheduling decision to enable simultaneous reception of the ROM service and unicast service in the same cell or different cells.

However, one thing that should not be overlooked in NR ROM support is the overhead caused by UE MII report for ROM services. Even if a network-controlled mechanism to turn on or off such a feature is introduced, there are still possible overheads including:

(1) Larger set of configurations for NR ROM. For NR Broadcast, an optimization may minimize the MCCH size, e.g., using some index to cover the common configuration among different MBS services, like DRX-ConfigPTM-Index-r17 and PDSCH-ConfigIndex-r17 in Rel-17. However, for a UE report to a network from another PLMN, such an optimization might not work, and there are still larger sets of configurations for such a report.

(2) In some cases, there might be a lot of UEs that are consuming the same ROM service and might initiate the same larger report at the same time. Such scenarios should not be overlooked as a broadcast reception is designed to support a large number of UEs.

(3) Such report might not be needed in the first place. There are also the same PLMN cases that the configuration might already be known to UE's PCell for the same operator. Therefore, if they are from the same operator, reporting one TMGI and cell information would be enough, and everything else would be wasting radio resources. The rest of it can be based on the network implementation with minimum overhead.

In some implementations of the disclosed technology, the information that a UE reports to a network may allow the network to be aware of the ROM service configurations that might occupy part of UE capability.

(1) ROM report. This report includes all the configurations needed to report to the network to allow the network to be aware of the scheduling decision of the broadcast service, and therefore can make a better scheduling decision for the unicast, e.g., to enable UE to simultaneously receive the unicast and broadcast services within UE capability, including handing over UE to a cell or carrier frequency that allows UE to do so. To avoid the overhead, the ROM report may include two parts as will be discussed below. It may also include the prioritized frequency information on which the ROM service is scheduled. Such information may be deduced by UE from the user service description (USD) and the system information broadcast from the cell where the ROM service is provided. Such deduction follows existing mechanism: USD provides the mapping between service ID, e.g., TMGI, and the service area ID, while in the system information provided at the access layer provides the mapping between service area ID and carrier frequency. Therefore, UE is able to know the mapping of service and carrier frequency, and thus may prioritize such frequency during cell re-selection.

(2) First part of the ROM report. To avoid the overhead brought by such a report (as mentioned in previous sections), UE may only need to report a minimum set of the ROM report to the network. It may include the service ID, e.g., the TMGI of the broadcast service, and the carrier information, which may include the frequency or the cell information, to uniquely identify the possible broadcast configuration.

(3) Second part of the ROM report. This part of ROM report includes the scheduling information that indicates the occupied UE capability by the ROM service. Based on such information, the network is able to schedule the unicast to UE that the UE capability allows. It may include the configuration of the ROM service UE is interested in receiving or is about to receive. The configuration may include numerology such as a sub-carrier spacing, service bandwidth, MBS radio bearer (MRB) and its configuration including the header compression for the MRB. Such information indicates the UE capability occupied by the ROM services.

(4) Update to the ROM report. Since the broadcast configuration that is decided by another network entity may update the configuration, such a configuration modification also needs to be known to the gNB where UE's RRC connection is established. Therefore, UE may need to indicate, to the network, the update to the ROM report.

The disclosed technology can be implemented in some embodiments to reduce the content UE needs to report, e.g., to allow UE to report the minimum set of contents, since a network might already know the related configuration, either by OAM, other UE's report, or network interfaces (which will be decided by RAN3). For example, UE may be required to send the first part of the ROM report in a first report, and the full ROM report or a second part ROM report in a second report.

The disclosed technology can be implemented in some embodiments to explicitly indicate to UE to report part or full configuration (e.g., broadcast signaling), or to trigger inquiry to UE in later phases. As for the configuration update, the network further indicates to UE whether or not such an update is needed to multiple UEs to initiate such a configuration update. Various implementations of features of the disclosed technology can be made based on the examples listed below.

### Example 1. A Network Indicates Partial or Full ROM Report

In one implementation, UE is indicated by a network to report partial or full ROM report, and therefore UE will not always or by default report the full ROM report.

In one example, the network may broadcast such an indication in the broadcast signaling, and the indication includes whether partial or full configuration is needed for the ROM service UE is interested in receiving or is about to receive. Upon receiving such an indication, if only part of the ROM set is needed, UE reports the first part of the ROM to the network, and if full configuration is needed for the ROM service, UE reports the full ROM report that includes both the configuration in the first part of the ROM and the configuration the second part of the ROM.

### Example 2. UE Reports the First Part, and Reports the Second Only when there are Network Inquires

In some implementations, the network inquires relate to the full ROM report based on the first part of the ROM report from UE. Upon receiving UE's first ROM report, if the network needs more information than this, the network can trigger UE to send such information by sending an inquiry to UE. UE follows network inquiry to trigger the second ROM report. In one example, the following operations can be performed:
(1) for one UE that is interested in receiving or is about to receive the ROM service, if the network allows and the trigger condition is met, UE reports the first part of the ROM report.
(2) UE receives an inquiry to report the second ROM report from the network.
(3) UE reports the second ROM report to the network.

### Example 3. Update of ROM Report

The ROM report to the network is provided to the network in a case that the ROM service configuration is updated. However, not all ROM report update is needed since the network can actively get such an update from part of the UEs, e.g., only selected UEs are required to carry out the ROM report. In one example, the following operations can be performed:
(1) for one UE that is interested in receiving or is about to receive the ROM service, if the network allows and the trigger condition is met, UE reports the first part ROM report.
(2) UE receives an indication on whether UE needs to send the updated ROM report to the network.
(3) if UE needs to send the updated ROM report to the network, UE reports the updated ROM report to the network; if UE does not need to send the updated ROM report to the network, UE does not report the updated ROM report to the network even when the ROM report has been updated as indicated by the cell that schedules the ROM services.

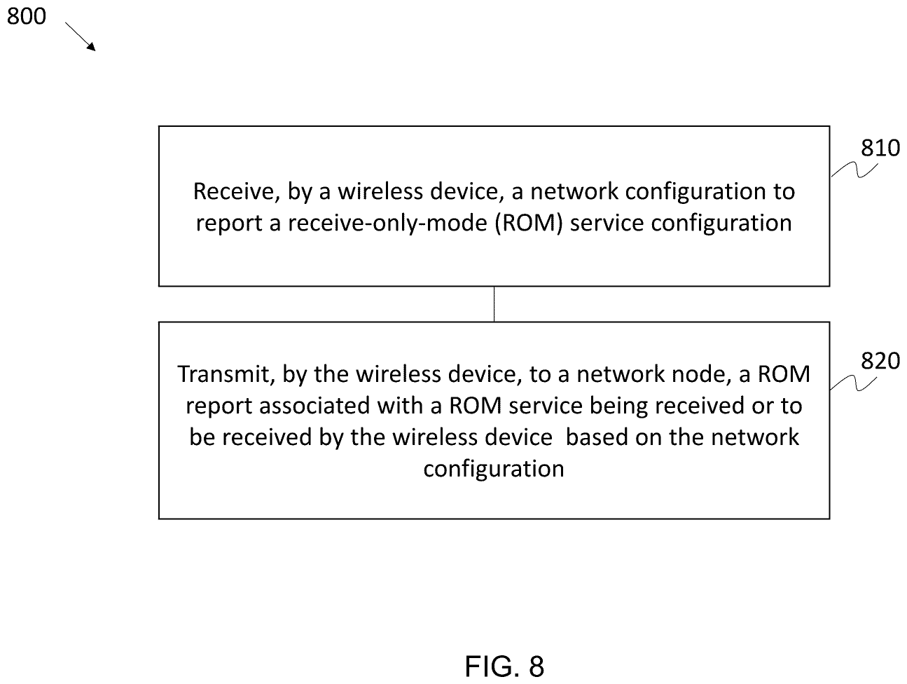

FIG. 8 shows another example of a process for wireless communication based on some example embodiments of the disclosed technology.

In some implementations, the process 800 for wireless communication may include, at 810, receiving, by a wireless device, a network configuration to report a receive-only-mode (ROM) service configuration, and, at 820, transmitting, by the wireless device, to a network node, a ROM report associated with a ROM service being received or to be received by the wireless device based on the network configuration.

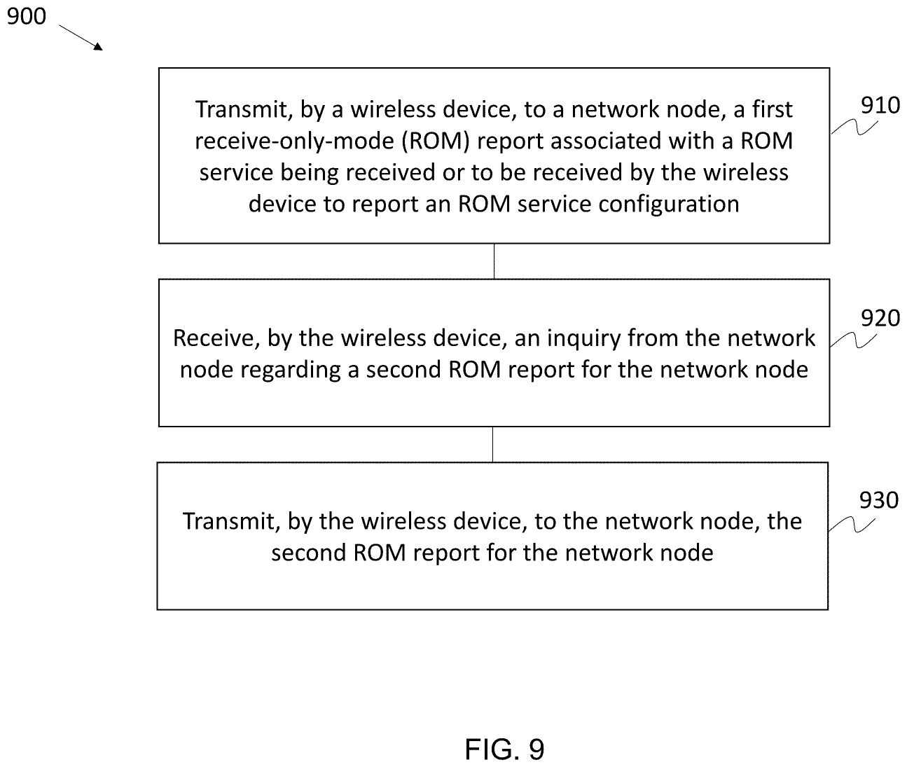

FIG. 9 shows another example of a process for wireless communication based on some example embodiments of the disclosed technology.

In some implementations, the process 900 for wireless communication may include, at 910, transmitting, by a wireless device, to a network node, a first receive-only-mode (ROM) report associated with a ROM service being received or to be received by the wireless device to report an ROM service configuration, at 920, receiving, by the wireless device, an inquiry from the network node regarding a second ROM report for the network node, and, at 930, transmitting, by the wireless device, to the network node, the second ROM report for the network node.

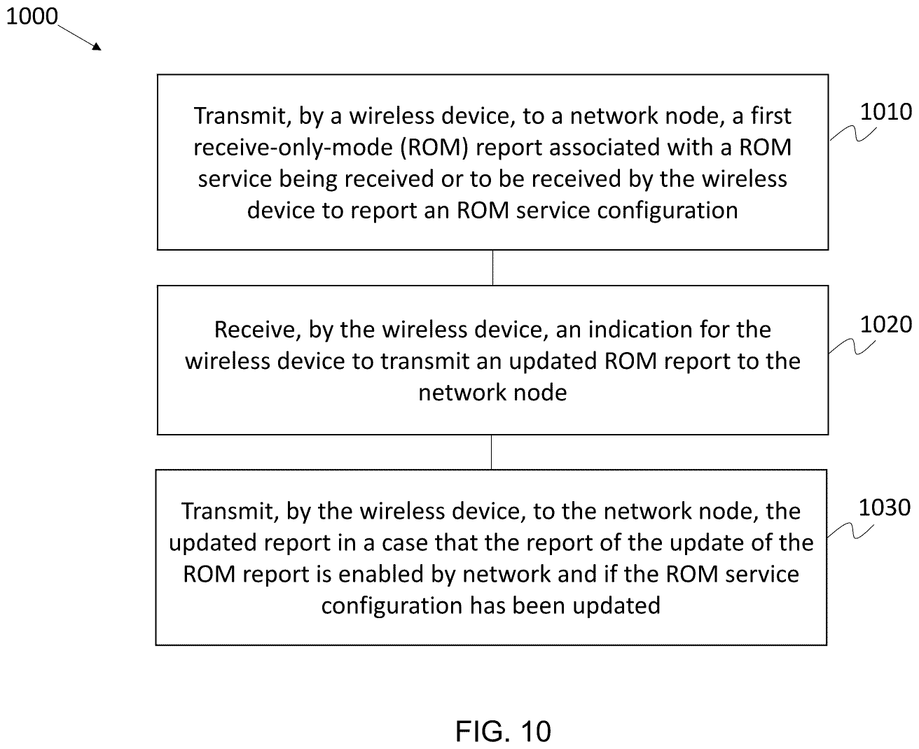

FIG. 10 shows another example of a process for wireless communication based on some example embodiments of the disclosed technology.

In some implementations, the process 1000 for wireless communication may include, at 1010, transmitting, by a wireless device, to a network node, a first receive-only-mode (ROM) report associated with a ROM service being received or to be received by the wireless device to report an ROM service configuration, at 1020, receiving, by the wireless device, an inquiry from the network node regarding a second ROM report for the network node, and, at 1030, transmitting, by the wireless device, to the network node, the second ROM report for the network node.

It will be appreciated that the present document discloses techniques that can be embodied in various embodiments to determine downlink control information in wireless networks. The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

Some embodiments may preferably implement one or more of the following solutions, listed in clause-format. The following clauses are supported and further described in the embodiments above and throughout this document. As used in the clauses below and in the claims, a wireless device may be user equipment, mobile station, or any other wireless terminal including fixed nodes such as base stations. A network device includes a base station including a next generation Node B (gNB), enhanced Node B (eNB), or any other device that performs as a base station.

Clause 1. A method of wireless communication, comprising: receiving, by a first network node, from a second network node, a session management signaling that include an alternative quality of service profile; and transmitting, by the first network node, to a wireless device, multicast session data based on the alternative quality of service profile during a radio resource control inactive period.

Clause 2. The method of clause 1, wherein the transmitting of the multicast session data includes, in a case that the alternative quality of service profile is received for one multicast session, scheduling the one multicast session for the wireless device during a radio resource control inactive period.

Clause 3. The method of clause 1, wherein the transmitting of the multicast session data includes: receiving an alternative quality of service profile priority list that includes a plurality of alternative quality of service profiles and priorities of the quality of service profiles; and scheduling a multicast session for the wireless device during a radio resource control inactive period based on a first alternative quality of service profile in the list that a first network node is capable of.

Clause 4. The method of clause 3, wherein the session management signaling further includes a notification control enabled indication, wherein, in a case that there is a multicast service to be scheduled for the wireless device during a radio resource control inactive period, the first network node triggers a notification to the second network node regarding a scheduling determination based on the alternative quality of service profile that the first network node is capable of satisfying.

Clause 5. The method of clause 3, wherein the session management signaling further includes a notification control enabled indication, wherein, in a case that there is a multicast service to be scheduled for the wireless device after the radio resource control inactive period transitions back to a radio resource control active period, the first network node triggers a notification to the second network node regarding a scheduling determination to allow the wireless device to receive the multicast session data during the radio resource control active period.

Clause 6. The method of clauses 1, 4 or 5, wherein the session management signaling is a protocol data unit (PDU) session management signaling for a PDU session of the wireless device associated with a multicast session.

Clause 7. The method of clauses 1, 4 or 5, wherein the session management signaling is a multicast session management signaling per multicast session.

Clause 8. A method of wireless communication, comprising: receiving, by a wireless device, a configuration associated with a multicast session from a network node, wherein the configuration assists the wireless device to receive or continue receiving the multicast session in one specific cell; and receiving, by the wireless device, multicast session data after transitioning to a radio resource control inactive state.

Clause 9. The method of clause 8, wherein the configuration associated with the multicast session includes cell information, wherein the method further comprises: selecting, by the wireless device, a cell with a highest priority based on the cell information; and receiving, by the wireless device, multicast session data after transitioning to a radio resource control inactive state, by camping on a cell indicated by the cell information.

Clause 10. The method of clause 8, wherein the configuration associated with the multicast session includes cell information and an offset value for a cell indicated by the cell information, wherein the method further comprises selecting, by the wireless device, a cell based on the offset value.

Clause 11. The method of clause 8, wherein the configuration associated with the multicast session includes scheduling information of the multicast session that includes cell information on a cell scheduled for the multicast session, wherein the method further comprises: selecting, by the wireless device, a cell with a highest priority based on the cell information; and receiving, by the wireless device, multicast session data after transitioning to a radio resource control inactive state, by camping on a cell indicated by the cell information.

Clause 12. The method of clause 8, wherein the receiving of the multicast session data after transitioning to the radio resource control inactive state includes maintaining, by the wireless device, a synchronization with the secondary cell and a multicast configuration associated with the secondary cell.

Clause 13. A method of wireless communication, comprising: obtaining, by a wireless device, assistant information provided from an application layer or a service layer to an access layer; and receiving, by the wireless device, a point-to-multipoint configuration associated with a multicast and broadcast service.

Clause 14. The method of clause 13, wherein the assistant information includes a temporary mobile group identity (TMGI) list that includes a TMGI associated with the multicast and broadcast service and each TMGI is separately configured by a different public land mobile network (PLMN).

Clause 15. The method of clause 14, wherein the TMGI list is included in a user service description provided in the service layer.

Clause 16. The method of clause 14, further comprising: comparing, by the wireless device, the TMGI list with a TMGI list in a multicast and broadcast service control channel (MCCH); and receiving, by the wireless device, multicast and broadcast service data based on the point-to-multipoint configuration identified by a recognized TMGI in the MCCH in a case that the recognized TMGI in the MCCH is also included in a TMGI list from the application layer or the service layer.

Clause 17. A method of wireless communication, comprising: receiving, by a wireless device, a network configuration to report a receive-only-mode (ROM) service configuration; and transmitting, by the wireless device, to a network node, a ROM report associated with a ROM service being received or to be received by the wireless device based on the network configuration.

Clause 18. The method of clause 17, wherein the network configuration includes an indication for the wireless device to transmit partial or full ROM report, wherein the wireless device transmits a first part of the ROM report, in a case that the indication is associated with the first part of the ROM report or allows the wireless device to indicate the first part of the ROM report to the network node, or the wireless device transmits the full ROM report if the indication is associated with the full ROM report or requires the wireless device to indicate the full ROM report to the network node.

Clause 19. The method of clause 18, wherein the first part of the ROM report includes a minimum set of ROM report for the network node to uniquely identify the ROM service to identify an associated scheduling configuration.

Clause 20. The method of clause 19, wherein the first part of the ROM report includes a service identity (ID) of the ROM service, and cell information associated with a cell where the ROM service is scheduled on.

Clause 21. The method of clause 18, wherein the full ROM report includes: a minimum set of ROM report for the network node to uniquely identify the ROM service; and scheduling information that indicates a UE capability occupied by the ROM service.

Clause 22. The method of clause 21, wherein the scheduling information includes at least one of: numerology of the ROM service configuration including a sub carrier spacing; a service bandwidth; or a multicast and broadcast service radio bearer (MRB) and a configuration of the MRB including a header compression for the MRB.

Clause 23. The method of clause 21, wherein the scheduling information includes frequency prioritization information that includes a list of frequencies that the ROM service is scheduled on.

Clause 24. A method of wireless communication, comprising: transmitting, by a wireless device, to a network node, a first receive-only-mode (ROM) report associated with a ROM service being received or to be received by the wireless device to report an ROM service configuration; receiving, by the wireless device, an inquiry from the network node regarding a second ROM report for the network node; and transmitting, by the wireless device, to the network node, the second ROM report for the network node.

Clause 25. The method of clause 24, wherein the first ROM report includes a minimum set of ROM report for the network node to uniquely identify the ROM service to identify an associated scheduling configuration.

Clause 26. The method of clause 25, wherein the first ROM report includes a service identity (ID) of the ROM service including a temporary mobile group identity of the ROM service, and cell information associated with a cell where the ROM service is scheduled on.

Clause 27. The method of clause 24, wherein the second ROM report includes scheduling information that indicates a UE capability occupied by the ROM service.

Clause 28. The method of clause 27, wherein the second ROM report includes at least one of: numerology of the ROM service configuration including a sub carrier spacing; a service bandwidth; or a multicast and broadcast service radio bearer (MRB) and a configuration of the MRB including a header compression for the MRB.

Clause 29. The method of clause 27, wherein the scheduling information includes frequency prioritization information that includes a list of frequencies that the ROM service is scheduled on.

Clause 30. A method of wireless communication, comprising: transmitting, by a wireless device, to a network node, a first receive-only-mode (ROM) report associated with a ROM service being received or to be received by the wireless device to report an ROM service configuration; receiving, by the wireless device, an indication for the wireless device to transmit an updated ROM report to the network node; and transmitting, by the wireless device, to the network node, the updated report in a case that the report of the update of the ROM report is enabled by network and if the ROM service configuration has been updated.

Clause 31. The method of clause 30, wherein the first ROM report includes a minimum set of ROM report for the network node to uniquely identify the ROM service to identify an associated scheduling configuration.

Clause 32. The method of clause 30, wherein the first ROM report and the updated ROM report include a minimum set of ROM report for the network node to uniquely identify the ROM service, and scheduling information that indicates a UE capability occupied by the ROM service.

Clause 33. An apparatus for wireless communication comprising a processor that is configured to carry out the method of any of clauses 1 to 32.

Clause 34. A non-transitory computer readable medium having code stored thereon, the code when executed by a processor, causing the processor to implement a method recited in any of clauses 1 to 32.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some implementations be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

What is claimed is:

1. A method of wireless communication, comprising:
receiving, by a first network node, from a second network node, a session management signaling that include an alternative quality of service profile; and
transmitting, by the first network node, to a wireless device, multicast session data based on the alternative quality of service profile during a radio resource control inactive period.

2. The method of claim 1, wherein the transmitting of the multicast session data includes, in a case that the alternative quality of service profile is received for one multicast session, scheduling the one multicast session for the wireless device during a radio resource control inactive period.

3. The method of claim 1, wherein the transmitting of the multicast session data includes:
receiving an alternative quality of service profile priority list that includes a plurality of alternative quality of service profiles and priorities of the quality of service profiles; and
scheduling a multicast session for the wireless device during a radio resource control inactive period based on a first alternative quality of service profile in the list that a first network node is capable of.

4. The method of claim 3, wherein the session management signaling further includes a notification control enabled indication, wherein, in a case that there is a multicast service to be scheduled for the wireless device during a radio resource control inactive period, the first network node triggers a notification to the second network node regarding a scheduling determination based on the alternative quality of service profile that the first network node is capable of satisfying.

5. The method of claim 3, wherein the session management signaling further includes a notification control enabled indication, wherein, in a case that there is a multicast service to be scheduled for the wireless device after the radio resource control inactive period transitions back to a radio resource control active period, the first network node triggers a notification to the second network node regarding a scheduling determination to allow the wireless device to receive the multicast session data during the radio resource control active period.

6. The method of claim 1, wherein the session management signaling is a protocol data unit (PDU) session management signaling for a PDU session of the wireless device associated with a multicast session.

7. The method of claim 1, wherein the session management signaling is a multicast session management signaling per multicast session.

8. A method of wireless communication, comprising:
receiving, by a wireless device, a configuration associated with a multicast session from a network node, wherein the configuration assists the wireless device to receive or continue receiving the multicast session in one specific cell; and
receiving, by the wireless device, multicast session data after transitioning to a radio resource control inactive state.

9. The method of claim 8, wherein the configuration associated with the multicast session includes cell information, wherein the method further comprises:
selecting, by the wireless device, a cell with a highest priority based on the cell information; and
receiving, by the wireless device, multicast session data after transitioning to a radio resource control inactive state, by camping on a cell indicated by the cell information.

10. The method of claim 8, wherein the configuration associated with the multicast session includes cell information and an offset value for a cell indicated by the cell information, wherein the method further comprises selecting, by the wireless device, a cell based on the offset value.

11. The method of claim 8, wherein the configuration associated with the multicast session includes scheduling information of the multicast session that includes cell information on a cell scheduled for the multicast session, wherein the method further comprises:
selecting, by the wireless device, a cell with a highest priority based on the cell information; and
receiving, by the wireless device, multicast session data after transitioning to a radio resource control inactive state, by camping on a cell indicated by the cell information.

12. The method of claim 8, wherein the receiving of the multicast session data after transitioning to the radio resource control inactive state includes maintaining, by the wireless device, a synchronization with a secondary cell and a multicast configuration associated with the secondary cell.

13. An apparatus for wireless communication comprising a processor that is configured to carry out a method comprising:
receiving, by a wireless device, a configuration associated with a multicast session from a network node, wherein the configuration assists the wireless device to receive or continue receiving the multicast session in one specific cell; and
receiving, by the wireless device, multicast session data after transitioning to a radio resource control inactive state.

14. The apparatus of claim 13, wherein the configuration associated with the multicast session includes cell information, wherein the method further comprises:
selecting, by the wireless device, a cell with a highest priority based on the cell information; and
receiving, by the wireless device, multicast session data after transitioning to a radio resource control inactive state, by camping on a cell indicated by the cell information.

15. The apparatus of claim 13, wherein the configuration associated with the multicast session includes cell information and an offset value for a cell indicated by the cell information, wherein the method further comprises selecting, by the wireless device, a cell based on the offset value.

16. The apparatus of claim 13, wherein the configuration associated with the multicast session includes scheduling information of the multicast session that includes cell information on a cell scheduled for the multicast session, wherein the method further comprises:
selecting, by the wireless device, a cell with a highest priority based on the cell information; and
receiving, by the wireless device, multicast session data after transitioning to a radio resource control inactive state, by camping on a cell indicated by the cell information.

17. The apparatus of claim 13, wherein the receiving of the multicast session data after transitioning to the radio resource control inactive state includes maintaining, by the wireless device, a synchronization with a secondary cell and a multicast configuration associated with the secondary cell.
